(19) United States
(12) Patent Application Publication
(10) Pub. No.: US 2017/0083894 A1
(43) Pub. Date: Mar. 23, 2017

(54) METHOD AND SYSTEM FOR DETERMINING A PREFERENCE OF A CUSTOMER FROM AN AGGREGATED PARTICIPATION LEVEL IN PAYMENT CARD CAMPAIGNS

(71) Applicant: MasterCard International Incorporated, Purchase, NY (US)

(72) Inventors: Sharan BAKSHIRAM, Gurgaon (IN); Avyaktanand TIWARY, Gurgaon (IN); Sheetanshu GUPTA, Gurgaon (IN)

(21) Appl. No.: 15/266,629

(22) Filed: Sep. 15, 2016

(30) Foreign Application Priority Data
Sep. 21, 2015 (SG) 10201507849Q

(51) Int. Cl. G06Q 20/22; G06Q 20/40; G06Q 30/02

(52) U.S. Cl. CPC G06Q 20/227; G06Q 30/0269; G06Q 20/405

(57) ABSTRACT

A method for determining a preference of a customer is provided. The method includes accepting registration of payments cards, creating a unique identifier, associating the unique identifier with the registered payment cards, and storing the associations in a reference table. The method further includes identifying transactions involving each of the registered payments cards, storing the transactions in a transaction table, and determining from the transactions in the transaction table and active payment card campaigns in a campaign table, the participation level in the active payment card campaigns for each of the registered payment cards. The method also includes determining that the registered payment cards share a common unique identifier, aggregating the participation level in the active payment card campaigns for each of the registered payment cards which share the common unique identifier, and determining the preference of the customer from the aggregated participation level.

### CROSS REFERENCE TO RELATED APPLICATIONS

This application claims the benefit of Singapore Patent Application No. 10201507849Q filed Sep. 21, 2015, which is hereby incorporated by reference in its entirety.

### BACKGROUND

The following discloses a method and system for determining a preference of a customer from an aggregated participation level of the customer in payment card campaigns. More particularly, the aggregated participation level involves the customer's participation levels in campaigns for payment cards issued by different payment card issuing companies.

Payment card campaigns are used by payment card issuing companies such as banks for incentivizing customers to purchase items with their payment cards (for example credit cards and debit cards). An example of a payment card campaign could be “spend $50 every day for this week with this credit card and get a free suitcase”. If the customer achieves the target set by the campaign, the payment card issuing company would then award the customer with the promised reward. From the customer's participation level in a campaign, the payment card issuing company can obtain an indication of the customer's spending habits and preferences.

However, a single payment card issuing company would not have a holistic view of the customer's participation level in campaigns across all of the customer's payment cards. This is because it is very common for a customer to possess payment cards issued by different payment card issuing companies, and a single payment card issuing company would only be privy to the customer's participation levels in campaigns for the payment cards issued by that payment card issuing company. A single payment card issuing company would simply not be aware of how many payment cards a customer actually has. Therefore, any information that can be discerned from a customer's participation levels in the campaigns such as the customer's preference, may be skewed and inaccurate as the payment card issuing companies would only have a micro view of the customer's spending habits and preferences, and not a macro one. For example, a customer's low participation level in a Starbucks® (Starbucks is a registered trademark of Starbucks Corporation) campaign for a particular payment card may not indicate that the customer does not have a preference for coffee. It could be that customer is already participating in other coffee related campaigns with payment cards issued by another payment card issuing company.

Therefore, there is a need for a method and system which can determine a preference of a customer from an aggregated participation level of customers in payment card campaigns, where the aggregated participation level involves the customer's participation levels in campaigns for payment cards issued by different payment card issuing companies.

Furthermore, payment card issuing companies do not update customers on their progress in the campaigns. By not knowing how far or how close one is from the target, the customers would lack the necessary motivation to perform the required actions or purchases to complete the campaign. Furthermore, customers are usually first informed of new campaigns via direct mailers which have a tendency to get misplaced. Customers may then forget the details of the campaign (for example: qualification criteria, target etc.) and would not have the means to access this information.

Therefore, there is also a need for a method and system to provide customers with campaign progress updates. Further, it is also desired that these campaign progress updates are customizable. In doing so, a customer would be able to check his current progress through a campaign at a time of his choosing, and select his preferred mode of receiving progress updates. Further still, there is also a need for a method and system that stores the details relating to the campaign as well as the progress of the customer in the campaign, and is capable of allowing the customer to view this information at his own volition.

Furthermore, other desirable features and characteristics will become apparent from the subsequent detailed description and the appended claims, taken in conjunction with the accompanying drawings and this background of the disclosure

### BRIEF DESCRIPTION

According to an aspect of the disclosure, a computer implemented method for determining a preference of a customer is provided. The method includes the steps of accepting, at a platform, registration of a plurality of payments cards belonging to the customer. The method also includes creating, at the platform, a unique identifier, associating the unique identifier with each of the plurality of registered payment cards, storing the associations in a reference table, identifying, at the platform, transactions involving each of the plurality of registered payments cards, and storing the transactions in a transaction table. The method further includes the steps of determining, from the transactions in the transaction table and active payment card campaigns in a campaign table, the participation level in the active payment card campaigns for each of the plurality of registered payment cards, and determining, from the associations in the reference table, that the plurality of registered payment cards share a common unique identifier. The method further includes the steps of aggregating the participation level in the active payment card campaigns for each of the plurality of registered payment cards which share the common unique identifier, and determining the preference of the customer from the aggregated participation level.

Preferably, the method further comprises the steps of designing a new payment card campaign based on the preference of the customer, adding the new payment card campaign to the active payment card campaigns, and introducing the new payment card campaign to one of the plurality of registered cards.

Preferably, the method further comprises the step of checking that the new payment card campaign does not have similar characteristics to any of the active payment card campaigns.

Preferably, the method further comprises the steps of choosing another payment card campaign based on the preference of the customer, adding the another payment card campaign to the active payment card campaigns, and introducing the another payment card campaign to one of the plurality of registered cards.

Preferably, the method further comprises the step of checking that the another payment card campaign does not have similar characteristics to any of the active payment card campaigns.

Preferably, the method further comprises the step of providing to the customer progress updates of the active payment card campaigns for each of the plurality of registered payment cards through a campaign progress account, the campaign progress account accessible via a web portal or via a client software application.

Preferably, the method further comprises the step of allowing the customer to specify on the campaign progress account, a frequency of receiving progress updates and a mode of receiving progress updates.

Preferably, the mode of receiving progress updates is at least one of: via text messages, via emails, and via social media notifications.

Preferably, the method further comprises the step of advertising the new payment card campaign and the another payment card campaign to the customer via the campaign progress account.

Preferably, the campaign progress account displays marketing communications or advertisements relevant to the preference of the customer.

Preferably, the progress updates are represented in the form of progress charts.

Preferably, the platform comprises a database, where the reference table, the transaction table, and the campaign table are stored in the database.

According to another aspect of the disclosure, a system for determining a preference of a customer is provided. The system including a platform, platform. The platform including at least one processor and a database. The database including a reference table, a transaction table, and a campaign table. The at least one processor is configured to accept registration of a plurality of payments cards belonging to the customer, create a unique identifier, associate the unique identifier with each of the plurality of registered payment cards, store the associations in the reference table, identify, at the platform, transactions involving each of the plurality of registered payments cards, and store the transactions in the transaction table. The at least one processor is further configured to determine, from the transactions in the transaction table and active payment card campaigns in the campaign table, the participation level in the active payment card campaigns for each of the plurality of registered payment cards, and determine, from the associations in the reference table, that the plurality of registered payment cards share a common unique identifier. The at least one processor is further configured to aggregate the participation level in the active payment card campaigns for each of the plurality of registered payment cards which share the common unique identifier, and determine the preference of the customer from the aggregated participation level.

Preferably, the at least one processor is further configured to provide to the customer progress updates of the active payment card campaigns for each of the plurality of registered payment cards through a campaign progress account, the campaign progress account accessible via a web portal or via a client software application.

Preferably, the campaign progress account allows the customer to specify a frequency of receiving progress updates and a mode of receiving progress updates.

Preferably, the mode of receiving progress updates is at least one of: via text messages, via emails, and via social media notifications.

Preferably, the campaign progress account displays marketing communications or advertisements relevant to the preference of the customer.

Preferably, the progress updates are represented in the form of progress charts.

According to another aspect of the disclosure, a computer program product for determining a preference of a customer is disclosed. The computer program product including a computer readable storage medium having computer readable program code configured to accept registration of a plurality of payments cards belonging to the customer, create a unique identifier, associate the unique identifier with each of the plurality of registered payment cards, store the associations in a reference table, identify, at the platform, transactions involving each of the plurality of registered payments cards, and store the transactions in a transaction table. The computer readable program code is further configured to determine, from the transactions in the transaction table and active payment card campaigns in a campaign table, the participation level in the active payment card campaigns for each of the plurality of registered payment cards, and determine, from the associations in the reference table, that the plurality of registered payment cards share a common unique identifier. The computer readable program code is further configured to aggregate the participation level in the active payment card campaigns for each of the plurality of registered payment cards which share the common unique identifier, and determine the preference of the customer from the aggregated participation level.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 shows a system in accordance with an embodiment of the disclosure.

FIG. 2 shows an exemplary platform for performing the functions in accordance with an embodiment of the disclosure.

FIG. 3 shows a flowchart that outlines the steps in which a customer registers with the platform in accordance with an embodiment of the disclosure.

FIG. 4 shows an exemplary reference table.

FIG. 5 shows a flowchart that outlines the steps in which platform determines a preference of a customer from an aggregated participation level of customers in payment card campaigns, in accordance with an embodiment of the disclosure.

FIG. 6 shows an exemplary transaction table.

FIG. 7 shows an exemplary campaign table.

FIG. 8 shows an exemplary illustration of an interface representing a campaign progress account in accordance with an embodiment of the disclosure.

### Skilled artisans will appreciate that elements in the figures are illustrated for simplicity and clarity and have not necessarily been depicted to scale.

For example, the dimensions of some of the elements in the block diagrams or steps in the flowcharts may be exaggerated in respect to other elements to help improve understanding of the present embodiment.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description. It is the intent of the preferred embodiments to disclose a method and system which can determine a preference of a customer from an aggregated participation level of the customer in payment card campaigns, where the aggregated participation level involves the customer's participation levels in campaigns for payment cards issued by different payment card issuing companies.

The disclosure achieves the above objectives by disclosing a platform that allows customers to register their payment cards (e.g., credit cards, debit cards) by furnishing information on their payment cards to the platform. An incentive for the customers to register their payment cards on the platform could be that for each of the payment cards, the platform would provide a mechanism for customers to receive campaign progress updates associated with that payment card. Upon registration, the platform would create a unique identifier, and associate the unique identifier with each of the customer's registered payment cards. These associations may be stored in the reference table in the platform. When transactions involving the payment cards occur, the platform may store the transaction data in a transaction table. From the transaction table and a campaign table listing the active payment card campaigns, the platform can determine a customer's participation level in payment card campaigns for each of the registered payment cards. From the reference table, the platform can determine which registered payment cards share the same unique identifier. The registered payment cards having the same unique identifier indicate that these registered payment cards belong to the same customer. The platform can therefore aggregate the participation level in payment card campaigns of each of the plurality of registered payment cards for that customer to determine the preference of the customer.

In doing so, the platform advantageously obtains a holistic view of the customer's participation rate in campaigns for payment cards issued by different payment card issuing companies. It is therefore possible to accurately determine the customer's interests and preferences and advantageously design new campaigns based on such interests and preferences. Existing campaigns which align with the interests of the customer can also therefore be offered to the customer, thereby maximizing the adoption and participation level of the campaigns. It is also possible to ascertain whether a new campaign would be readily adopted by the customer. For example, more often than not, a customer would not adopt a new campaign which bears similar characteristics to an ongoing campaign which he is already participating in. Therefore these “duplicate” campaigns can be filtered out and will not be recommended to the customer. Furthermore, through this platform, the spending behavior of a customer, through his adoption of the campaigns across his various payment cards can be identified. This is advantageous because determining a customer's spending behavior by looking at his adoption of campaigns on payment cards issued by a single payment card issuing company in isolation is highly inaccurate. This is because the customer may be participating in a similar campaign with a payment card from another payment card issuing company which skews the results. By treating the customer's spending behavior as the sum of the adoption of campaigns across his various payment cards, an accurate depiction of his actual spending pattern and preferences can be obtained.

In an embodiment of the disclosure, a platform that allows customers to access their progress on their campaigns, and allows customers to customize the campaign progress updates is provided. Customers are able to customize settings so that they receive progress updates at their preferred frequency and in their preferred mode of delivery (email or text message etc.) The platform can also serve as an advertising medium by which marketing communications and advertisements can be sent to customers. Furthermore, the disclosed platform can also function as a cost effective medium for new campaigns to be advertised and communicated to the customers. Typically, customers are first informed of new campaigns via direct mailers which is an expensive form of communication. Therefore, the disclosed platform can obviate the need to send costly direct mailers by providing a cost effective channel to the customers.

Furthermore, the platform is also capable of allowing customers to view their progress on campaigns at their own volition. This is advantageous because the duration of the campaigns is usually short (a few days or weeks). Therefore, to facilitate the completion of the campaign, it is important that a customer's progress in the campaign be available as and when the customer requires it. The platform can also allow customers to customize the frequency and mode of receiving the campaign progress updates.

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

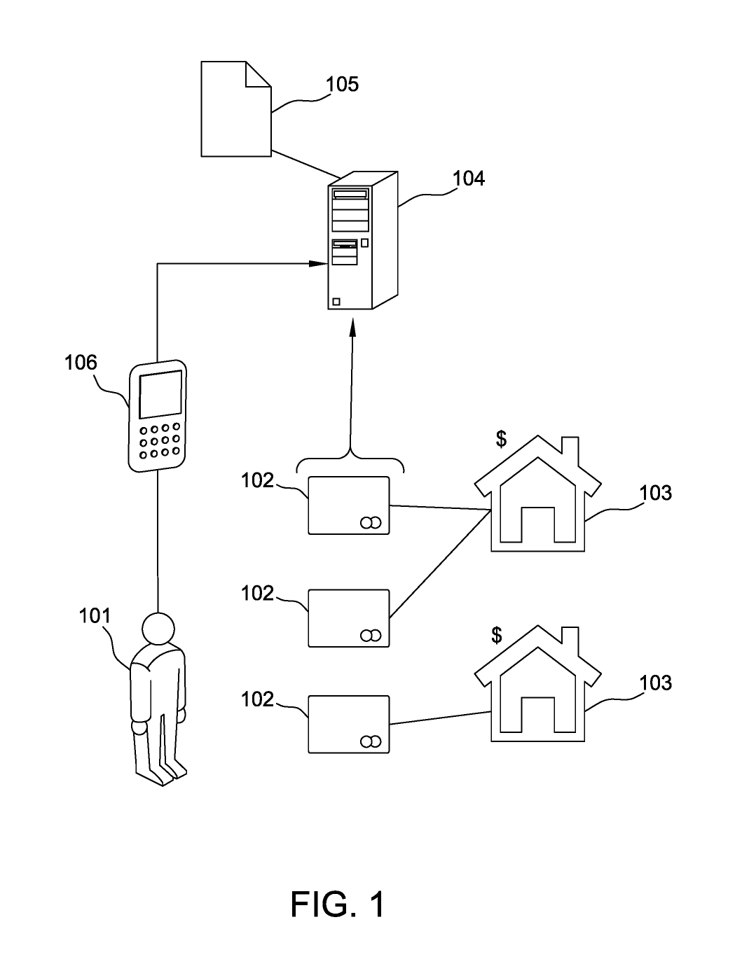

FIG. 1 shows a system in accordance with an embodiment of the disclosure. In the system, customer 101 has multiple payment cards 102 issued by multiple payment card issuing companies 103. Customer 101 registers with platform 104 by providing the details of payment cards 102 to platform 104. Platform 104 may be maintained or managed by a payment processing company, for example, MasterCard®. (MasterCard is a registered trademark of MasterCard International Incorporated located in Purchase, New York). Preferably, upon completion of registration, platform 104 creates campaign progress account 105 for customer 101. Customer 101 can access his campaign progress account 105 via any computing device 106. Computing device 106 can be any electronic device, non-exhaustively including, a smart phone, a handheld, a tablet, a laptop computer or a desktop computer or the like.

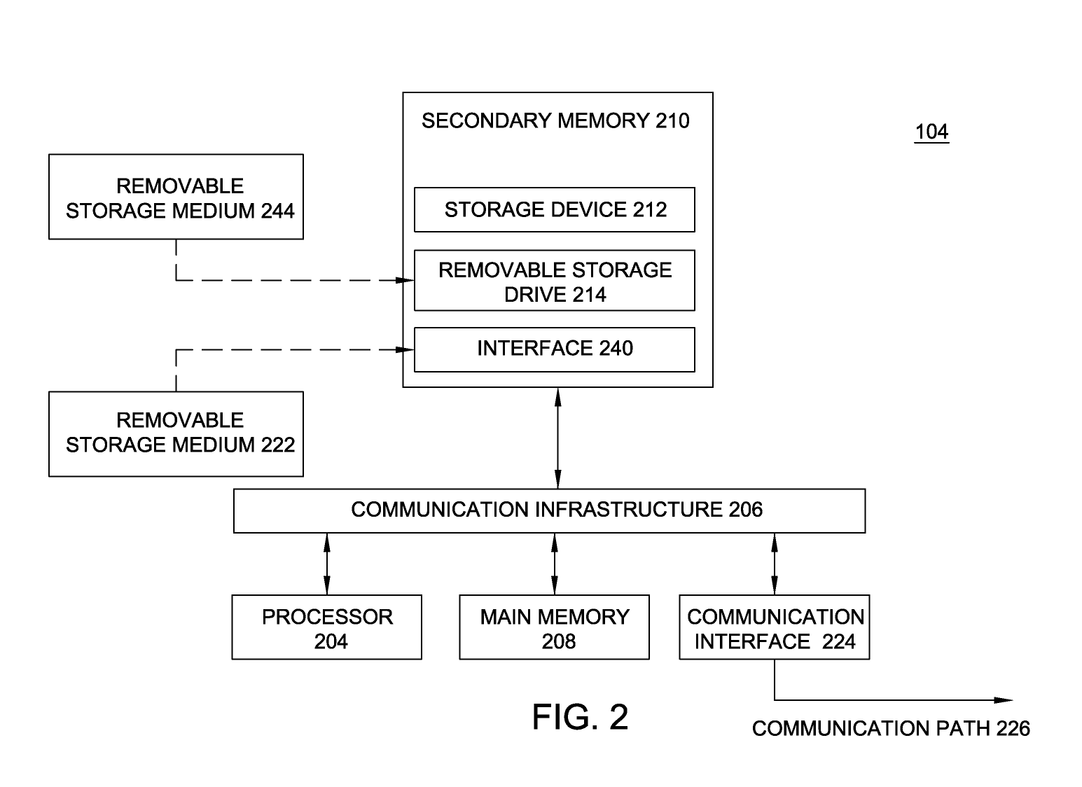

The following description of platform 104 is provided by way of example only and is not intended to be limiting. Platform 104 may comprise of a server or a plurality of servers. As shown in FIG. 2, the exemplary platform 104 includes a processor 204 for executing software routines. Although a single processor is shown for the sake of clarity, platform 104 may also include a multi-processor system. The processor 204 is connected to a communication infrastructure 206 for communication with other components of platform 104. The communication infrastructure 206 may include, for example, a communications bus, cross-bar, or network. Platform 104 further includes a main memory 208, such as a random access memory (RAM), and a secondary memory 210.

The secondary memory 210 may include, for example, a storage drive 212, which may be, but is not limited to, a hard disk drive, a solid state drive, a hybrid drive, or a removable storage drive 214, which may include a magnetic tape drive, an optical disk drive, a solid state storage drive (such as a USB flash drive, a flash memory device, a solid state drive or a memory card), or the like. The removable storage drive 214 reads from and writes to a removable storage medium 244 in a well-known manner. The removable storage medium 244 may include magnetic tape, optical disk, non-volatile memory storage medium, or the like, which is read by and written to by removable storage drive 214. As will be appreciated by persons skilled in the relevant art(s), the removable storage medium 244 includes a computer readable storage medium having stored therein computer executable program code instructions or data. In an alternative implementation, the secondary memory 210 may additionally or alternatively include other similar means for allowing computer programs or other instructions to be loaded into platform 104. Such means can include, for example, a removable storage unit 222. Examples of a removable storage unit 222 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 222 which allow software and data to be transferred from the removable storage unit 222 to platform 104.

Platform 104 also includes at least one communication interface 224. The communication interface 224 allows software and data to be transferred between platform 104 and external devices via a communication path 226. In various embodiments of the disclosure, the communication interface 224 permits data to be transferred between platform 104 and a data communication network, such as a public data or private data communication network. Examples of a communication interface 224 can include a modem, a network interface (such as an Ethernet card), a communication port (such as a serial, parallel, printer, GPIB, IEEE 1394, RJ45, USB), an antenna with associated circuitry and the like. The communication interface 224 may be wired or may be wireless. Software and data transferred via the communication interface 224 are in the form of signals which can be electronic, electromagnetic, optical or other signals capable of being received by communication interface 224. These signals are provided to the communication interface via the communication path 226.

Software may be stored in a computer program product and loaded into platform 104 using the removable storage drive 214, the storage drive 212, or the interface 240. Alternatively, the computer program product may be downloaded to platform 104 over the communications path 226. The software, when executed by the processor 204, causes platform 104 to perform functions of embodiments described herein. It is to be understood that the embodiment of FIG. 2 is presented merely by way of example. Therefore, in some embodiments one or more features of platform 104 may be omitted. Also, in some embodiments, one or more features of platform 104 may be combined together. Additionally, in some embodiments, one or more features of platform 104 may be split into one or more component parts.

As used herein, the term “computer program product” may refer, in part, to removable storage medium 244, removable storage unit 222, a hard disk installed in storage drive 212, or a carrier wave carrying software over communication path 226 (wireless link or cable) to communication interface 224. Computer readable storage media refers to any non-transitory, non-volatile tangible storage medium that provides recorded instructions or data to platform 104 for execution or processing. Examples of such storage media include magnetic tape, CD-ROM, DVD, Blu-ray® Disc (Blu-ray is a registered trademark of Blu-ray Disc Association), a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of platform 104. Examples of transitory or non-tangible computer readable transmission media that may also participate in the provision of software, application programs, instructions or data to platform 104 include radio or infra-red transmission channels as well as a network connection to another computer or networked device, and the Internet or Intranets including e-mail transmissions and information recorded on Websites and the like.

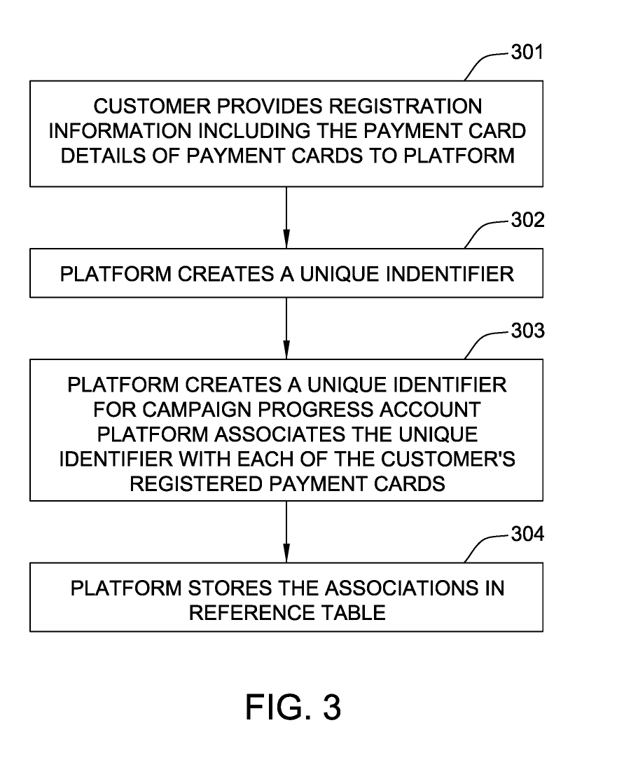

FIG. 3 shows a flowchart that outlines the steps in which customer 101 registers with platform 104 in accordance with an embodiment of the disclosure.

In step 301, customer 101 provides registration information including the payment card details of payment cards 102 to platform 104. The payment card details can include the payment card number, the type of the payment card (credit card or debit card), the customer's name on the payment card and the expiry date of the payment card. The registration information can also include the customer's identification card number, passport number, postal address, email address, phone number, and any other personal information relating to customer 101.

In an embodiment of the disclosure, an incentive for customer 101 to register their payment cards 102 on platform 104 could be that for each of the registered payment cards 102, platform 104 would provide to the customer 101 progress updates of the payment card campaigns for each of registered payment cards 102. Preferably, progress updates is provided to customer 101 through campaign progress account 105. Preferably, campaign progress account 105 allows customer 101 to customise the frequency of receiving progress updates and the mode of receiving progress updates. The mode of receiving progress updates can include via text messages, via emails and via social media notifications. Preferably, campaign progress account 105 may be accessible via a web portal or on a client software application. Customer 101 can download client software application onto computing device 106. Platform 104 would then push campaign progress data down to update client software application on computing device 106. Alternatively, customer 101 can navigate to a web portal hosted on platform 104. Through the web portal, customer 101 would be able to access any active campaigns applicable to his registered payment cards 102 and view and track campaign progress account 105.

In step 302, platform 104 creates a unique identifier.

In step 303, platform 104 associates the unique identifier with each of the customer's registered payment cards 102.

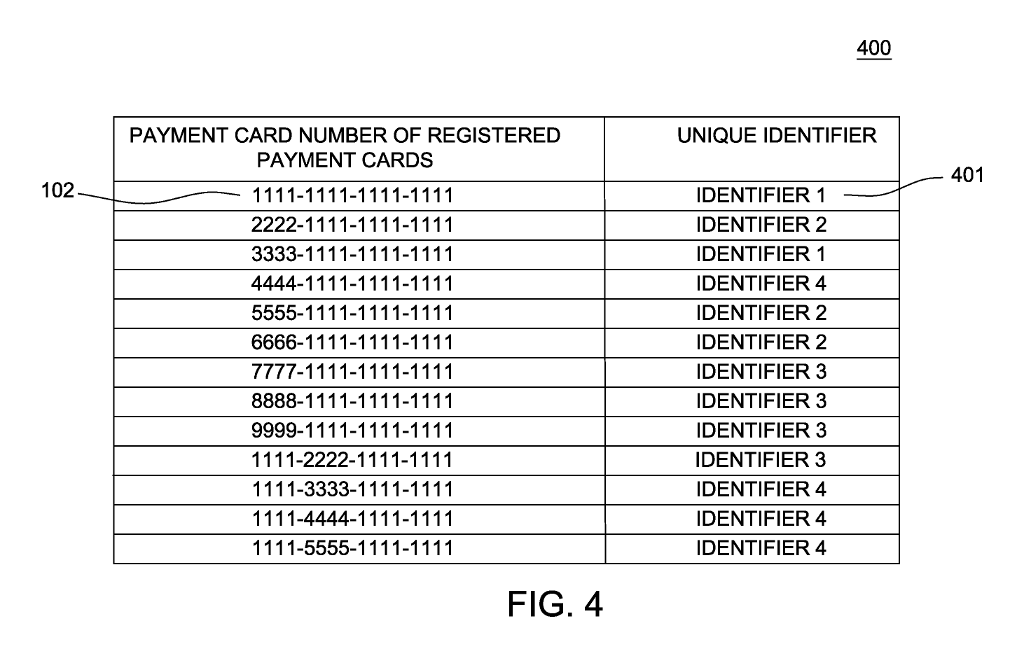

In step 304, platform 104 stores the associations in reference table 400 (see FIG. 4). FIG. 4 provides an exemplary reference table 400 having exemplary values. In reference table 400, each registered payment card 102 has an associated unique identifier 401. As can be seen from reference table 400, a plurality of registered payment cards 102 can share a common unique identifier 401. For example, registered payment cards “1111-1111-1111-1111” and “3333-1111-1111-1111” share the same unique identifier i.e. “identifier 1”, while “2222-1111-1111-1111” is associated with “identifier 2”, and “4444-1111-1111-1111” is associated with “identifier 4”. Platform 104 recognizes that each unique identifier in reference table 400 represents a unique individual or unique customer 101. This is advantageous as through reference table 400, platform 104 is able to identify the registered payment cards 102 that belong to a particular customer 101. Preferably, reference table 400 is stored in a database in platform 104. Alternatively, reference table 400 can be stored in an external database which platform 104 can access.

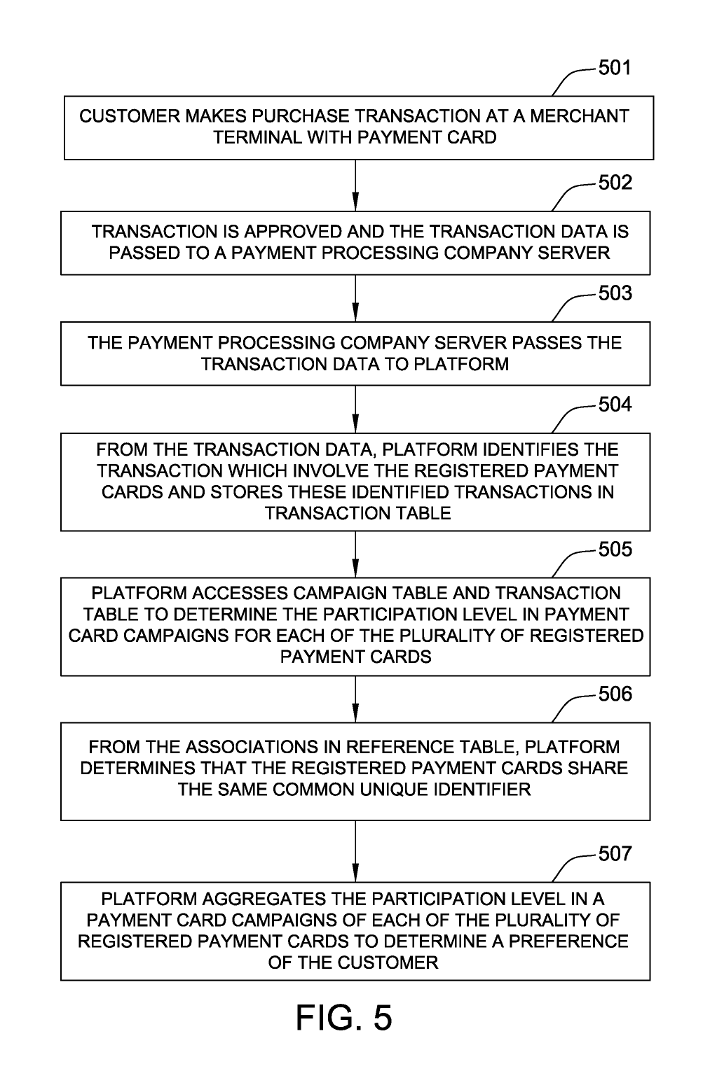

FIG. 5 shows a flowchart that outlines the steps in which platform 104 determines a preference of a customer from an aggregated participation level of customers in payment card campaigns, in accordance with an embodiment of the disclosure.

In step 501, customer 101 makes a purchase transaction at a merchant terminal with payment card 102. In step 502, the transaction is approved by the payment card issuing company and the transaction data is passed to a payment processing company server. In step 503, the payment processing company server passes the transaction data to platform 104.

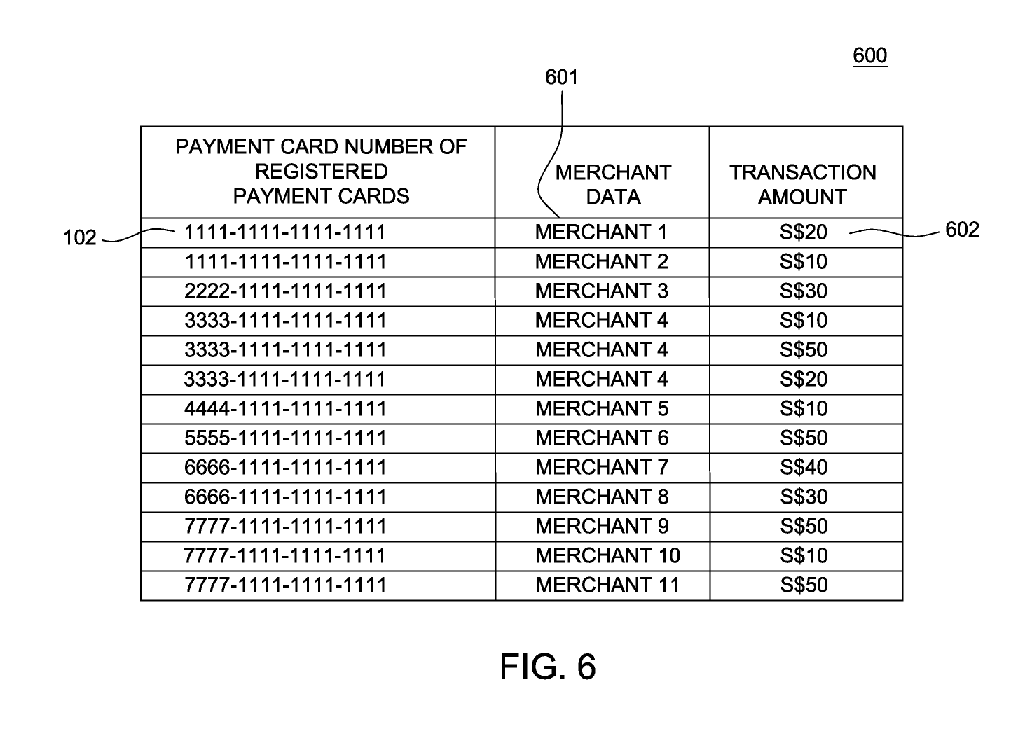

In step 504, from the transaction data, platform 104 identifies the transactions which involve the registered payment cards 102 and stores these identified transactions in transaction table 600 (see FIG. 6). FIG. 6 provides an exemplary transaction table 600 having exemplary values. Preferably, transaction table 600 includes the payment card number of each of the registered payment cards 102, merchant data 601 and transaction amount 602. As can be seen from transaction table 600, one registered payment card 102 can have a plurality of transactions stored in transaction table 600. Preferably, transaction table 600 is stored in the database in platform 104. Alternatively, transaction table 600 can be stored in an external database which platform 104 can access.

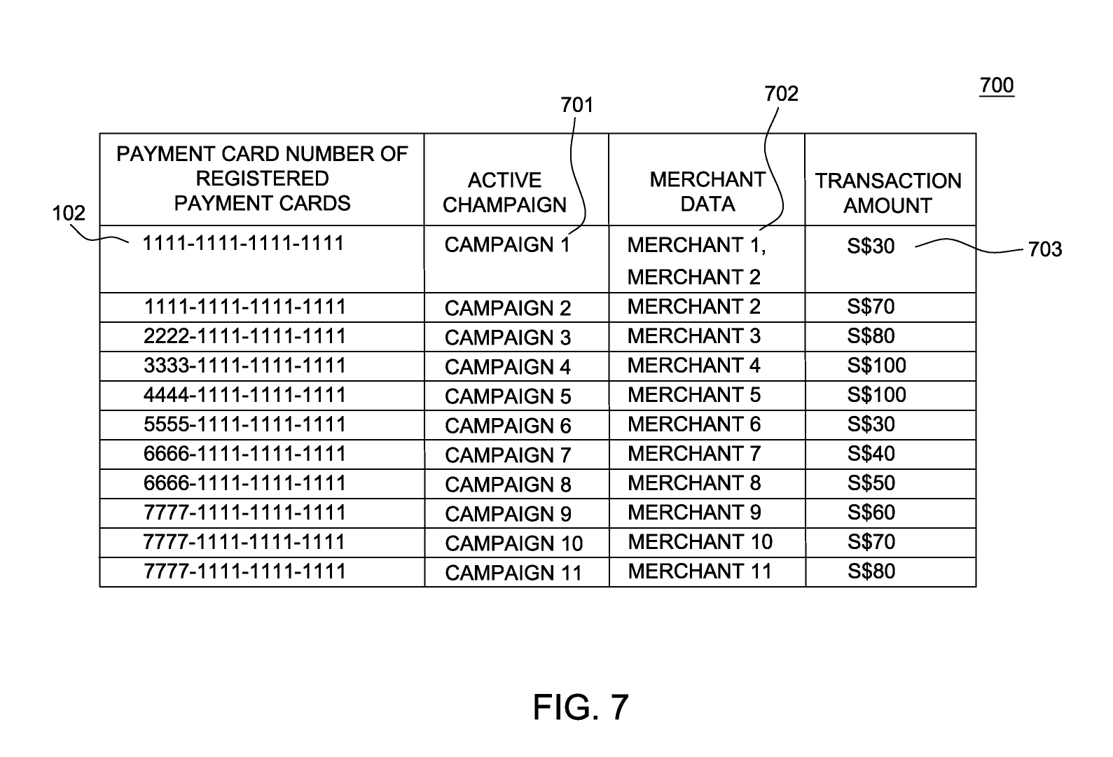

In step 505, platform 104 accesses campaign table 700 (see FIG. 7) and transaction table 600 to determine the participation level in payment card campaigns for each of the plurality of registered payment cards 102. FIG. 7 provides an exemplary campaign table 700 having exemplary data. Preferably, campaign table 700 includes the payment card number of each of the registered payment cards 102, the active campaigns 701 of each of the registered payment cards 102, the participating merchants 702 in the active campaigns 701, and the target of the campaign 703. Preferably, the data in campaign table 700 is updated when active campaign 701 for registered payment card 102 commences. For example, when the communication mailers are sent out to customers 101 to inform that “campaign 1” has commenced or has launched, “campaign 1” and its relevant data will be updated as active campaign 701 in campaign table 700. Preferably, the data in campaign table 700 can be obtained from parties who design and formulate the campaigns, such as payment card issuing companies 103. The data in campaign table 700 can also be obtained from payment processing companies. Preferably, campaign table 700 is stored in a database in platform 104. Alternatively, campaign table 700 can be stored in an external database which platform 104 can access. Platform 104 can determine the participation level in each of the active campaigns 701 by using payment card number of registered payment card 102 as a key for transaction table 600 and campaign table 700, and summing up the transaction amounts 602 to see the deviation from the target of campaign 703. For example, the transaction amounts for registered payment card “3333-1111-1111-1111” total up to $80 ($50 plus $20 plus $10). Therefore, the participation level in “campaign 4” is 0.8 ($80 over $100). In another example, the transaction amounts for registered payment card “1111-1111-1111-1111” total up to $30. Therefore, the participation level in campaign 1 is 1.0 ($30 over $30) or complete participation.

In step 506, from the associations in reference table 400, platform 104 determines that the registered payment cards 102 share the same common unique identifier 401. For example, platform 102 determines that registered payment cards “1111-1111-1111-1111” and “3333-1111-1111-1111” share the same common unique identifier “identifier 1”. This indicates that registered payment cards “1111-1111-1111-1111” and “3333-1111-1111-1111” belong to the same customer 101.

In step 507, platform 104 aggregates the participation level in payment card campaigns of each of the plurality of registered payment cards 102 to determine a preference of customer 101. If “campaign 1” and “campaign 4” both relate to motor vehicle campaigns, due to the high participation level for both “campaign 1” (complete participation) and “campaign 4” (which has a participation level of 0.8), platform 104 determines that customer 101 has a high preference for motor vehicle campaigns. The preference of customer 101 can be shared with parties who design and formulate the campaigns, such as payment card issuing companies 103. Knowing the customer's 101 preferences will be very useful in the formulation and design of new campaigns 701 as the campaigns 701 can be catered and provided to a target population of card holders to which it would most likely resonate with. New campaigns 701 can be designed based on the preference of customer 101, and the new campaigns 701 can be introduced to registered payment cards 102. Existing campaigns 701 which match the preference of customer 101 can also be chosen and the existing campaigns 701 can be introduced to registered payment cards 102.

Providing campaigns 701 which align with the preferences of customer 101 advantageously maximizes the adoption and participation rate of campaigns 701. For example, if customer 101 seems to be particularly keen on campaigns 701 which are motor vehicle related, this implies that customer 101 owns a motor vehicle and uses it on a regular basis. Therefore motor vehicle-related campaigns 701 can be provided to customer 101. Furthermore, the reward in the motor vehicle-related campaigns 701 can be tailored to have a motor vehicle-related theme, for example, free car wash, free car servicing etc.

As platform 104 has a holistic or macro view of the registered payment cards 102 for a particular customer 101, platform 104 can advantageously help avoid the introduction of “duplicate” campaigns to the registered payment cards 102 of customer 101. “Duplicate” campaigns are campaigns 701 which have similar characteristics for example, same merchant, same target etc. For example, if payment card issuing company 103 intends to introduce a new campaign 701 to a registered payment card 102 belonging to customer 101, platform 104 can first check to see whether there are already any active campaigns 701 for any of the registered payment cards 102 belonging to customer 101 which share similar characteristics to the new campaign 701. If so, platform 104 can inform payment card issuing company 103. Payment card issuing company 103 should then not introduce the new campaign 701 to registered payment card 102 belonging to customer 101 as “duplicate” campaigns will most likely incite a lower participation level from customer 101.

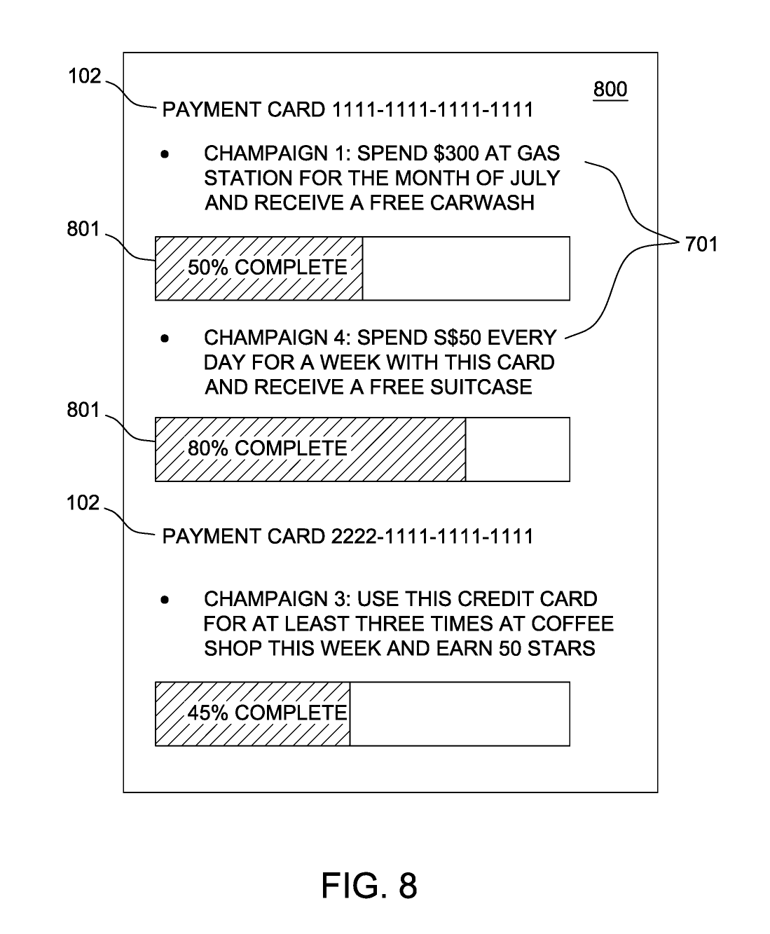

Campaign progress account 105 can be represented or displayed in an interface 800. An exemplary illustration of interface 800 is shown in FIG. 8. Interface 800 can be viewed on the client software application on computing device 106 or on the web portal. Progress charts 801 for each individual campaign 701 for each registered payment card 102 are provided in interface 800. From progress charts 801, customer 101 can easily discern how much more is required to achieve the target of campaigns 701. Although progress charts 801 have been shown as progress bars, other intuitive graphical representations are possible. For example, pie charts, meters etc.

In an embodiment of the disclosure, interface 800 of campaign progress account can include settings for customer 101 to specify the mode of receiving the progress updates. For example, customer 101 can specify the mode of receiving the progress updates to be via text messages, emails or social media notifications. Preferably, interface 800 can also allow customer 101 to set the frequency of the progress updates (for example, after every transaction, every hour, every 12 hours, every day or every week etc.) Preferably, interface 800 can also serve as an advertising medium in which marketing communications and advertisements relevant to the preference of customer 101 can be sent from platform 104 to customer 101.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. A computer implemented method for determining a preference of a customer comprising the steps of:
accepting, at a platform, registration of a plurality of payments cards belonging to the customer;
creating, at the platform, a unique identifier, associating the unique identifier with each of the plurality of registere payment cards, and storing the associations in a reference table;
identifying, at the platform, transactions involving each of the plurality of registered payments cards, and storing the transactions in a transaction table;
determining, from the transactions in the transaction table and active payment card campaigns in a campaign table, the participation level in the active payment card campaigns for each of the plurality of registered payment cards;
determining, from the associations in the reference table, that the plurality of registered payment cards share a common unique identifier;
aggregating the participation level in the active payment card campaigns for each of the plurality of registered payment cards which share the common unique identifier; and
determining the preference of the customer from the aggregated participation level.

2. The method of claim 1 further comprising the steps of:
designing a new payment card campaign based on the preference of the customer;
adding the new payment card campaign to the active payment card campaigns; and
introducing the new payment card campaign to one of the plurality of registered cards.

3. The method of claim 2 further comprising the step of checking that the new payment card campaign does not have similar characteristics to any of the active payment card campaigns.

4. The method of claim 1 further comprising the steps of:
choosing another payment card campaign based on the preference of the customer;
adding the another payment card campaign to the active payment card campaigns; and
introducing the another payment card campaign to one of the plurality of registered cards.

5. The method of claim 4 further comprising the step of checking that the another payment card campaign does not have similar characteristics to any of the active payment card campaigns.

6. The method claim 1 further comprising the step of providing to the customer progress updates of the active payment card campaigns for each of the plurality of registered payment cards through a campaign progress account, the campaign progress account accessible via a web portal or via a client software application.

7. The method of claim 6 further comprising the step of allowing the customer to specify on the campaign progress account, a frequency of receiving progress updates and a mode of receiving progress updates.

8. The method of claim 7, wherein the mode of receiving progress updates is at least one of: via text messages, via emails, and via social media notifications.

9. The method of claim 6 further comprising the step of advertising the new payment card campaign and the another payment card campaign to the customer via the campaign progress account.

10. The method of claim 6 wherein the campaign progress account displays marketing communications or advertisements relevant to the preference of the customer.

11. The method of claim 6, wherein the progress updates are represented in the form of progress charts.

12. The method of claim 1, wherein the platform comprises a database, and wherein the reference table, the transaction table table, and the campaign table are stored in the database.

13. A system for determining a preference of a customer, the system comprising a platform, the platform comprising at least one processor and a database, the database comprising a reference table, a transaction table and a campaign table, the at least one processor configured to:
accept registration of a plurality of payments cards belonging to the customer;
create a unique identifier, associate the unique identifier with each of the plurality of registered payment cards, and store the associations in the reference table;
identify, at the platform, transactions involving each of the plurality of registered payments cards, and store the transactions in the transaction table;
determine, from the transactions in the transaction table and active payment card campaigns in the campaign table, the participation level in the active payment card campaigns for each of the plurality of registered payment cards;
determine, from the associations in the reference table, that the plurality of registered payment cards share a common unique identifier;
aggregate the participation level in the active payment card campaigns for each of the plurality of registered payment cards which share the common unique identifier; and
determine the preference of the customer from the aggregated participation level.

14. The system of claim 13, wherein the at least one processor is further configured to provide to the customer progress updates of the active payment card campaigns for each of the plurality of registered payment cards through a campaign progress account, the campaign progress account accessible via a web portal or via a client software application.

15. The system of claim 13, wherein the campaign progress account allows the customer to specify a frequency of receiving progress updates and a mode of receiving progress updates.

16. The system of claim 15, wherein the mode of receiving progress updates is at least one of: via text messages, via emails, and via social media notifications.

17. The system of claim 13, wherein the campaign progress account displays marketing communications or advertisements relevant to the preference of the customer.

18. The system of claim 13, wherein the progress updates are represented in the form of progress charts.

19. A computer program product for determining a preference of a customer, the computer program product having a computer readable storage medium having computer readable program code configured to:
accept registration of a plurality of payments cards belonging to the customer;
create a unique identifier, associating the unique identifier with each of the plurality of registered payment cards, and store the associations in a reference table;
identify, at the platform, transactions involving each of the plurality of registered payments cards, and store the transactions in a transaction table;
determine, from the transactions in the transaction table and active payment card campaigns in a campaign table, the participation level in the active payment card campaigns for each of the plurality of registered payment cards;
determine, from the associations in the reference table, that the plurality of registered payment cards share a common unique identifier;
aggregate the participation level in the active payment card campaigns for each of the plurality of registered payment cards which share the common unique identifier; and
determine the preference of the customer from the aggregated participation level.
